(19) United States
(12) Patent Application Publication
(10) Pub. No.: US 2025/0146754 A1
(43) Pub. Date: May 8, 2025

(54) ROTARY PYROLYSIS REACTOR AND METHOD OF USE

(71) Applicant: Omega Holdings LLC, Lawrence, KS (US)

(72) Inventors: Bijoy Thomas, Independence, KS (US); Nathan Coltrane, Independence, KS (US); Ronald Hoover, Independence, KS (US); Thomas Workman, Altamont, KS (US); Chad Johnson, Independence, KS (US)

(73) Assignee: Omega Holdings LLC, Lawrence, KS (US)

(21) Appl. No.: 18/500,290

(22) Filed: Nov. 2, 2023

(51) Int. Cl. F27B 7/08; F27B 7/16; F27B 7/22; F27B 7/24; F27B 7/28; F27B 7/32; F27B 7/34

(52) U.S. Cl. CPC F27B 7/08; F27B 7/161; F27B 7/224; F27B 7/24; F27B 7/28; F27B 7/3205; F27B 7/34

(57) ABSTRACT

A thermal treatment reactor for feedstocks and method of use. The thermal treatment reactor comprises an infeed assembly, a furnace, a rotary drum, a discharge assembly, and a liberator assembly. The rotary drum may comprise forwarding flights, mixing flights, oscillating flights, and raking pins. The feedstock to be thermally treated enters the reactor through the infeed assembly. The feedstock is fed into the reactor in a controlled manner by means of a screw conveyor system. The thermally-treated product exits the reactor via the discharge assembly, which separates the thermally treated product into a VOC liberator, from whence the product enters into a cooling system to reduce the temperature for safe storage and handling.

### TECHNICAL FIELD OF THE INVENTION

The present invention relates generally to apparatuses and systems for treating feedstocks and, more particularly, but not by way of limitation, to thermal treatment reactors for thermalizing solid organic and inorganic feedstocks while limiting reactor fouling. Methods of thermalizing carbonaceous and non-carbonaceous feedstocks are also provided.

### SUMMARY OF THE INVENTION

The present invention is directed to a thermal treatment reactor for feedstocks, the thermal treatment reactor comprising: a furnace for thermally treating a feedstock; and a rotary drum having an interior in which are positioned: a plurality of mixing flights; and a forwarding flight to move the feedstock toward the plurality of mixing flights; wherein the forwarding flight and at least a portion of the plurality of mixing flights are insulated to prevent condensation on the interior of the rotary drum.

The present invention further is directed to a method of treating organic or inorganic feedstocks, the method comprising the steps of: feeding the feedstock into a rotary drum held in a stationary furnace to thermally treat the feedstock; and insulating the rotary drum to prevent condensation of volatiles.

### BRIEF DESCRIPTION OF THE DRAWINGS

FIG. 1 is a perspective view of an illustrative thermal treatment reactor constructed in accordance with an embodiment of the present invention.

FIG. 2 is a top plan view of the illustrative thermal treatment reactor of FIG. 1.

FIG. 3 is a cross-sectional view of the illustrative thermal treatment reactor of FIG. 2, taken along line 3-3.

FIG. 4 is a side view of the illustrative thermal treatment reactor of FIG. 1 showing an illustrative angular orientation of the rotary drum.

FIG. 5 is a side view of the illustrative thermal treatment reactor of FIG. 1.

FIG. 6 is a cross-sectional view of the illustrative thermal treatment reactor of FIG. 5, taken along line 6-6.

FIG. 7 is cross-sectional view of the illustrative thermal treatment reactor of FIG. 5, taken along line 7-7.

FIG. 8 is an anterior end view of the illustrative thermal treatment reactor of FIG. 1.

FIG. 9 is a posterior end view of the illustrative thermal treatment reactor of FIG. 1.

### DETAILED DESCRIPTION OF THE INVENTION

Efforts to develop reliable, cost-effective alternative energy sources to traditional fossil fuels have multiplied over the past decades. A number of factors have driven this effort, including environmental interests, which have stimulated the development of clean and renewable technologies for transforming organic and inorganic waste resources into feedstocks for conversion into new fuels, products and energy. Millions of tons of waste are produced each year that can be transformed into biofuels, bioproducts or electricity.

A variety of both organic and inorganic feedstocks are transformable through technological processes to produce clean and renewal energies and products. Biomass feedstocks include agricultural residues, such as corn stover, wheat straw, rice husks, sugarcane bagasse, hemp and algae, and dedicated energy crops, such as switchgrass, miscanthus, energy cane, sweet sorghum, high biomass sorghum, hybrid poplars, and shrub willows. Forestry residues, such as logging residues and forest thinning make suitable feedstocks for various purposes. Waste streams and re-useable carbon sources, such as non-recyclable organic portions of municipal solid waste, biosolids, sludges, waste food, plastics, and manure slurries comprise both organic and inorganic feedstocks.

Renewable liquid fuels are derived from non-fossil origin materials, including non-food organic waste, such as used vegetable oil, animal fat and agri-food, and industry waste, such as biogas, forestry and farming waste, renewable hydrogen and captured CO₂. These liquid fuels can release up to 90% less CO₂ than conventional fuels. Renewable syngas is derived from wood, waste wood, cellulose or lignin.

Organic soil amendments are a composition of organic medieties derived from biomass and/or from living organisms, such as compost, wood chips, biochar, animal manure, straw, husk, geotextile, and sewage sludge. Inorganic or mineral amendments enhance soil fertility and incorporate gypsum, lime or limestone to normalize soil pH, while coal combustion byproducts, such as fly ash, can increase the pH of soil compositions.

Conventional technologies exist for converting organic and inorganic feedstocks into useful products and energy, including anaerobic and aerobic digestion, fermentation, enzymatic or acid hydrolysis, combustion, gasification, torrefaction, pyrolysis and hydrothermal liquefaction. Torrefaction and pyrolysis, also called thermal-treatment, are processes by which heat is applied to a feedstock in an oxygen-starved environment to sanitize, decompose and chemically convert and valorize the feedstock into a stable and usable end product.

Conventional thermal reactors used in pyrolysis are prone to chemical fouling attributable to the condensation of volatile organic compounds liberated from the process and buildup of limescale and other mineral deposits in the reactor and associated tubing. Dosing of the reactor and treatment fluids with chemical agents and salts are helpful in preventing buildup and in cleaning the reactor; however, these chemical agents can be harmful and corrosive. Biological fouling caused by biological agents such as algae, mussels, and final filtered effluent (FFE) can be treated with UV radiation to reduce the biological load on the equipment or by caustic cleaning of the equipment, which must be built to withstand caustic chemicals. Deposition fouling is caused by sedimentation of particulates or by baking of sediment onto the components of the reactor. Corrosion fouling results from a reaction with a material from which the reactor is made due to the presence of high temperatures and/or corrosive chemicals.

The present invention provides a thermal treatment reactor to thermalize feedstocks while limiting reactor fouling. The present invention also provides a thermal treatment reactor that produces a product that is hydrophobic and friable and that possesses a lower oxygen to carbon ratio, as well as a byproduct consisting of renewable syngas. Additionally, the thermal treatment reactor of the present invention can significantly reduce the volume of feedstocks, thereby mitigating disposal costs when applied to organic wastes. The thermal treatment, or pyrolysis, reactor of the present invention induces a thermochemical change in a feedstock, rendering the feedstock with unique properties, including hydrophobicity, friability and electronegativity. In addition, the thermal treatment reactor of the present invention increases the net calorific value of the final product, increases the specific surface area, and increases resistance to biological degradation, while also mitigating biological activity, odor and vector attraction, which is the characteristic of an organic material that attracts rodents, flies, mosquitos, or other organisms capable of transporting infectious agents. These properties enable the use of such feedstocks in a variety of applications, including renewable energy, renewable liquid fuels, renewable syngas, organic soil amendment, air and gas filtration systems, graphene production.

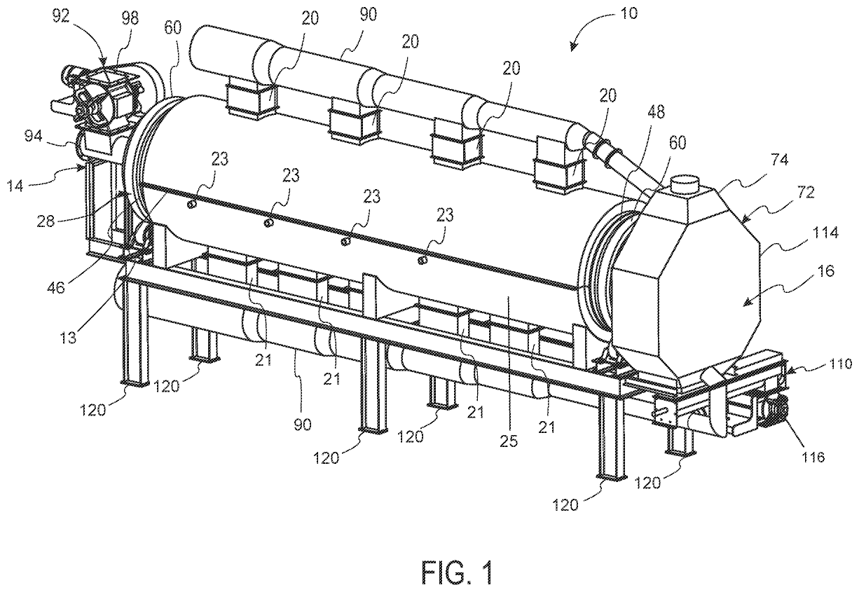

Turning now to the drawings in general, and to FIGS. 1, 2 and 3 in particular, there is shown therein an illustrative thermal treatment reactor 10 constructed in accordance with an embodiment of the present invention. The thermal treatment reactor 10 is suitable for use in a variety of applications, including, without limitation, renewable energy, renewable liquid fuels, renewable syngas, organic soil amendment, air and gas filtration systems, and graphene production.

The thermal treatment reactor 10 is suitable for use in applications employing either solid organic or solid inorganic feedstocks, or both. Some suitable organic feedstocks include biomass, agricultural residues, biological residues, algae, dedicated energy crops, forestry residues, waste streams, re-useable carbon sources, municipal solid waste, biosolids, sludges, waste food, plastics, and manure slurries. Some suitable inorganic feedstocks are those feedstocks comprising an inorganic component, including, without limitation, soils, limestone, magnesite, vermiculite, potassium, calcium, and sodium silicon. These feedstocks constitute primarily minerals that generally have an organic content of less than 10% by weight. The feedstocks suitable for use in the invention may have a recommended moisture content less than 20% on a wet basis. In one embodiment of the invention, the feedstock has a moisture content of less than 10% on a wet basis.

The thermal treatment reactor 10 of the present invention enables thermal treating of feedstocks either for their beneficial reuse or for enhancing their utilization efficiency. An example of the former would be remediation of soils contaminated by an oil or chemical spill. The subject invention can be utilized to volatilize the contaminant from the soil to render the soil benign and thereby fit for use. Another example of the same category would be remediation of feedstocks contaminated with Poly-Fluro Alkyl Substances (PFAS), a class of forever chemicals commonly found in many everyday products, microplastics, and the like, that could be volatilized from contaminated feedstocks to produce a benign product for reuse. An example of the latter, wherein the utilization efficiency of an inorganic feedstock can be enhanced, would be the case of crushed limestone being heated in the thermal treatment reactor to produce a preheated (hot) product before being mixed with asphalt in the production of roofing shingles. The preheated limestone can effectively improve the mixability of limestone with asphalt, reducing the usage of asphalt and thereby reducing production costs.

The dimensions of the thermal treatment reactor 10 are variable and depend upon the volume and type of materials to be processed through the thermal treatment reactor. The length of the thermal treatment reactor 10 generally ranges from at least about 5 feet to at least about 100 feet. The diameter of the thermal treatment reactor 10 generally ranges from about 1 foot to about 20 feet. Diameters are to outside diameters, unless specifically stated to reference an inner diameter. It will be appreciated, however, that the thermal treatment reactor 10 may be any diameter and length suited for conditions for the application and site where in use. The thermal treatment reactor 10, and the components thereof, preferably, though not necessarily, comply with the American National Standards Institute (ANSI) quality standards and dimensions and the biochar produced comply with the Biochar Standards of the International Biochar Initiative.

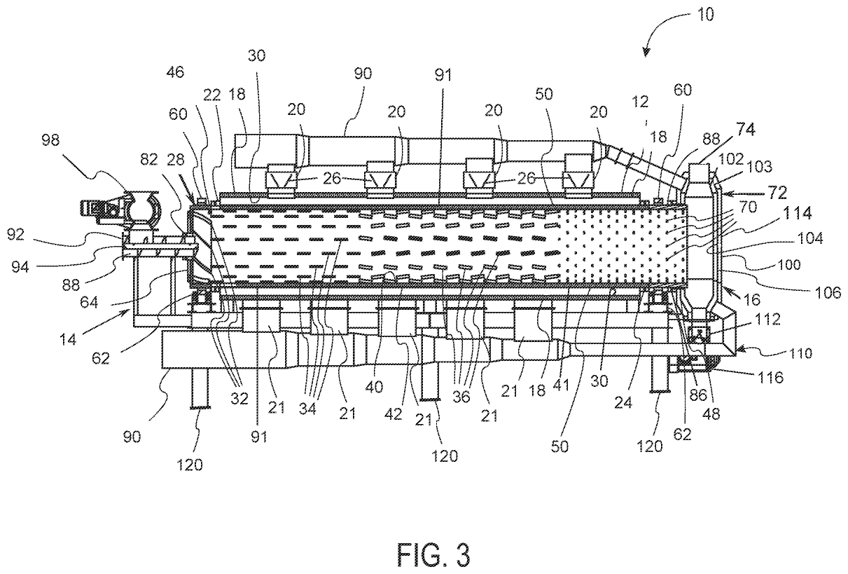

The thermal treatment reactor 10 defines an anterior end 14 and a posterior end 16 and comprises a furnace 12 for thermally treating a feedstock. The furnace 12 will receive hot gases emanating from a thermal energy source (not shown). After treatment, the treated feedstock may be referred to as thermally-treated product. The furnace 12 may be constructed of multiple components or may be an integral one-piece unit. A flange 13 may be formed where components of the furnace 12 are joined. The furnace 12 may be lined with a thermal blanket or insulating refractory material 18, made from materials such as ceramic blanket, alumina, tungsten, molybdenum, niobium, tantalum, rhenium, calcium silicate, kaolin, zirconia, silica brick, magnesite, and chromite. The furnace 12 may comprise one or more heat intake ports 21 and one or more heat discharge ports 20, and such ports may be equipped with heat control dampers, also called gas flow control dampers adapted to receive, distribute and release hot gases from the furnace. The heat intake ports 21 and heat discharge ports 20 are adapted to distribute the hot gases to uniformly heat the rotary drum 28. The heat intake ports 21 and heat discharge ports 20 may also comprise a plurality of heat control dampers or hot gas flow control dampers. In one embodiment of the invention, the heat discharge ports 20 are positioned on a top side of the furnace 12, while the heat intake ports 21 may be positioned underneath the furnace, and may optionally comprise dampers 26, as shown in FIG. 3 for controlling the flow of hot gasses emanating from the thermal energy source into the furnace. The dampers optionally may be electrically-actuated.

The thermal treatment reactor 10 may further comprise a plurality of infrared thermocouples 23 mounted on an exterior surface 25 of the furnace 12. The infrared thermocouples 23 are equipped with a built-in detecting system (not shown) that receives heat energy from a radiating device, in this case the rotary drum 28, at which the sensor is aimed. The detection system converts the heat energy to an electric potential to measure the temperature of the radiating device, or the rotary drum 28 in this case. The plurality of infrared thermocouples 23 measures the temperature of the rotary drum 28 at various points along its length. The process control can be achieved either by dedicating one of the thermocouples as the measuring point or by taking an average of two or more of the infrared thermocouples 23 mounted on the thermal treatment reactor 10.

One or more furnace seals, such as anterior furnace seal 22 and posterior furnace seal 24, may also be provided and are configured to prevent the ingress of ambient air into the furnace 12. In one embodiment of the invention, the furnace 12 is stationary.

The furnace 12 of the thermal treatment reactor 10 may be made be of any material suitable for use in processing feedstocks, including steel, pressure-vessel grade steel, abrasion-resistant steel, stainless steel, stainless chrome-plated, copper, stainless with nickel/silicon carbide composite coating, carbonitrided steel, nickel carbide plated steel, a nickel-chromium based alloy, such as Inconel®, a nickel-chromium-molybdenum based alloy, such as Hastelloy®, and tempered steel. It will be appreciated that the furnace 12 may be produced from other materials suited to the particular temperatures, pressures, fluids, applications, feedstocks, and other conditions of use.

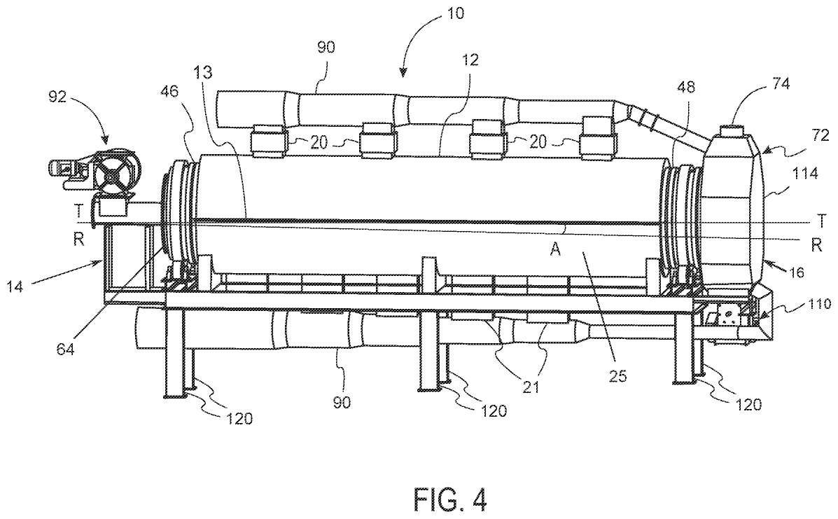

In one embodiment of the invention, the furnace 12 of the thermal treatment reactor 10 comprises a vessel that is generally horizontal in orientation and generally cylindrical in shape. The thermal treatment reactor 10 further comprises a rotary drum 28 which may be positioned within an interior space 30 of the furnace 12 and may be rotatable therewithin. In one embodiment of the invention, the rotary drum 28 is supported at a slope on the thermal treatment reactor 10, for a purpose yet to be described, thereby forming an angle A formed between the abscissa of the furnace 12, illustrated in FIG. 4 by the line T-T, and the centerline R-R of the rotary drum 28, also shown in FIG. 4. The rotary drum 28 and the furnace 12 are positioned concentric to each other. In one embodiment of the invention, this angle A ranges from about 0.1 degrees to about 20 degrees, and in another embodiment of the invention, this angle A ranges from about 0.5 degrees to 15 degrees. Although the rotary drum 28 is positioned within the furnace 12, a portion of the rotary drum 28 may protrude outside one or both ends of the furnace 12. The portion of the rotary drum 28 positioned within the furnace 12 is referred to as the heated zone. The thermal treatment reactor 10 is supported on or above a substrate by legs 120.

Returning now to FIG. 3, the rotary drum 28 forms an interior 40 and an exterior surface 41, and may further comprise a plurality of forwarding flights 32 positioned proximal to the anterior end 14 of the thermal treatment reactor 10 within the interior 40 of the rotary drum. The forwarding flights 32 move the feedstock towards the interior 40 of the rotary drum for further processing within the interior of rotary drum 28. The forwarding flights 32 may form various geometries and profiles, although in one embodiment of the invention the forwarding flights are generally planar in shape and are positioned angularly with respect to the rotary drum for the purpose of forwarding the feedstock into the interior 40 of the rotary drum 28 for further processing. It will be appreciated that the forwarding flights 32 may be any shape and configuration adapted to move the feedstock into the interior 40 of the rotary drum 28, including without limitation, cylindrical or conical. The number of forwarding flights 32 varies depending upon the size of the thermal treatment reactor 10, the size of the rotary drum 28, the volume and type of feedstock being processed, the application for which the thermal treatment reactor is employed and other conditions at the site where in use. In one embodiment of the invention, there are three forwarding flights 32 positioned proximal the anterior end 14 of the thermal treatment reactor 10. The forwarding flights 32 are made of the same material as the rotary drum 28 or, in some cases, may be constructed of a different material, depending on the type of feedstock, process, and product requirements.

The forwarding flights 32 are supported or secured within the interior 40 of the rotary drum 28 by welding, bolts or other means, depending on the type of feedstock and product requirements. The forwarding flights 32 may be located in an anterior end portion 46 of the rotary drum 28 which protrudes outside the end of the furnace 12 for a purpose yet to be described. The forwarding flights 32 are either insulated from the atmosphere or are held within the heated zone of the rotary drum 28 to prevent condensation on the interior 40 of the rotary drum 28.

The forwarding flights 32 transport the feedstock toward a plurality of mixing flights 34 positioned within the interior 40 of the rotary drum 28 adjacent the forwarding flights. The plurality of mixing flights 34 comprise various geometries and profiles and are adapted to achieve uniform mixing of feedstock within the rotary drum 28. The plurality of mixing flights 34 are positioned in a generally planar and horizontal position on an interior wall 42 forming the interior 40 of the rotary drum 28. It will be appreciated that the mixing flights 34 may be any shape and configuration adapted to mix the feedstock within the interior 40 of the rotary drum 28.

The number of the plurality of mixing flights 34 varies, depending upon the size of the thermal treatment reactor 10, the size of the rotary drum 28, the volume and type of feedstock being processed, the application for which the thermal treatment reactor 10 is employed and other conditions at the site where in use. In one embodiment of the invention, there are multiple rows of mixing flights 34 positioned generally equidistantly in staggered rows on the interior wall 42 forming the interior 40 toward the anterior end 14 of the thermal treatment reactor 10. Other spacings and configurations suitable for use in the invention include a non-staggered arrangement of the mixing flights 34. The flight profiles could be varied depending on the type of the feedstock and product requirements. The mixing flights 34 are designed to gradually and consistently overturn the material while limiting lifting and veiling of the material within the rotary drum 28 to prevent material breakage and carryover of fines out of the rotary drum 28.

The mixing flights 34 are made of the same material as the rotary drum 28 or, in some cases, may be constructed of a different material, depending on the type of feedstock and product requirements. The mixing flights 34 are supported or secured within the interior 40 of the rotary drum 28 by welding, bolts or other means, depending on the type of feedstock and product requirements. At least a portion of the plurality of the mixing flights 34 are insulated from the atmosphere or are held within the heated zone of the rotary drum to prevent condensation of volatile organic compounds on the interior 40 of the rotary drum 28

The mixing flights 34 transport the feedstock toward a plurality of oscillating flights 36 positioned within the interior 40 of the rotary drum 28 proximal to the posterior end 16 of the thermal treatment reactor 10. The plurality of oscillating flights 36 comprise various geometries and profiles and are adapted to achieve uniform mixing of feedstock within the rotary drum 28. The plurality of oscillating flights 36 is positioned in a generally planar but offset configuration on the interior wall 42 forming the interior 40 of the rotary drum 28. It will be appreciated that the oscillating flights 36 may be any shape and configuration adapted to mix the feedstock within the interior 40 of the rotary drum 28. The oscillating flights 36 are held within the heated zone of the rotary drum 28 to prevent condensation on the interior 40 of the rotary drum.

The number of oscillating flights 36 varies, depending upon the size of the thermal treatment reactor 10, the size of the rotary drum 28, the volume and type of feedstock being processed, the application for which the thermal treatment reactor 10 is employed and other conditions at the site where in use. In one embodiment of the invention, there are multiple rows of oscillating flights 36 positioned generally equidistantly in staggered rows on the interior wall 42 forming the interior 40 of the rotary drum 28 of the thermal treatment reactor 10; however, the oscillating flights may be offset with respect to each other to further facilitate mixing of the feedstock. It will be appreciated that other spacings and configurations of oscillating flights would be suitable for use in the invention.

The oscillating flights 36 are made of the same material as the rotary drum 28 or, in some cases, may be constructed of a different material, depending on the type of feedstock and product requirements. The oscillating flights 36 are supported or secured within the interior 40 of the rotary drum 28 by welding, bolts or other means, depending on the type of feedstock and product requirements. The oscillating flights 36 are insulated from the atmosphere by being held within the heated zone of the rotary drum 28 to prevent condensation of volatile organic compounds on the interior 40 of the rotary drum.

It will be appreciated that this sequence of forwarding flights 32, mixing flights 34 and oscillating flights 36 and the number of zones of flights within the rotary drum 28 is one possible sequence of flights. The types of flights, the sequence of flights, the configuration of flights and the number of flight zones within the rotary drum 28 may vary. Additionally, another possible configuration is a combination of mixing flights 34 and oscillating flights 36 within the same zone or region of the rotary drum 28. The feedstock upon entering the rotary drum 28 is fibrous and tough. It is important that the feedstock is adequately mixed while also making and maintaining contact with the hot rotary drum 28 to heat the fibrous, tough feedstock while limiting comminution to minimize generation of dust. The sequence, configuration, allocation, number and types of forwarding flights, mixing flights and oscillating flights and zones will vary based on the type of feedstock and the desired properties of the end product.

With continuing reference to FIGS. 1, 2 and 3, it now will be appreciated that the rotary drum 28 may not be completely housed within the furnace 12. To that end, the rotary drum 28 forms the anterior end portion 46 and a posterior end portion 48 which protrude outside the ends of the furnace 12. The portion of the rotary drum 28 positioned outside the furnace 12 further comprises a double wall having two layers and insulation between the two layers of the double wall. In one embodiment of the invention, the double-walled construction of the rotary drum 28 is limited to the sections of the rotary drum protruding outside the furnace 12 at the anterior end 14 and posterior end 16. The double-walled construction of the rotary drum 28 is insulated with a thermal blanket or insulating refractory material made from materials such as ceramic blanket, alumina, tungsten, molybdenum, niobium, tantalum, rhenium, calcium silicate, kaolin, zirconia, silica brick, magnesite, and chromite.

The double-walled construction of the rotary drum 28 also facilitates the placement of drum tracks 60 on which are received the anterior end portion 46 and the posterior end portion 48 of the rotary drum to facilitate rotation thereof. The drum tracks 60 are supported on trunnion wheels (not shown) mounted onto trunnion bases 62, and a drum sprocket 64 is mounted over the rotary drum 28 at the anterior end portion 46 thereof. In one embodiment of the invention, the drum tracks 60 are mounted onto the rotary drum 28 by means of a three-piece wedge assembly creating an air-gap, which prevents overheating of the drum tracks 60 and enhances longevity of the drum tracks. The rotary drum 28 is driven by means of a variable-speed motor and drive (not shown) suitable for the power requirements of the application.

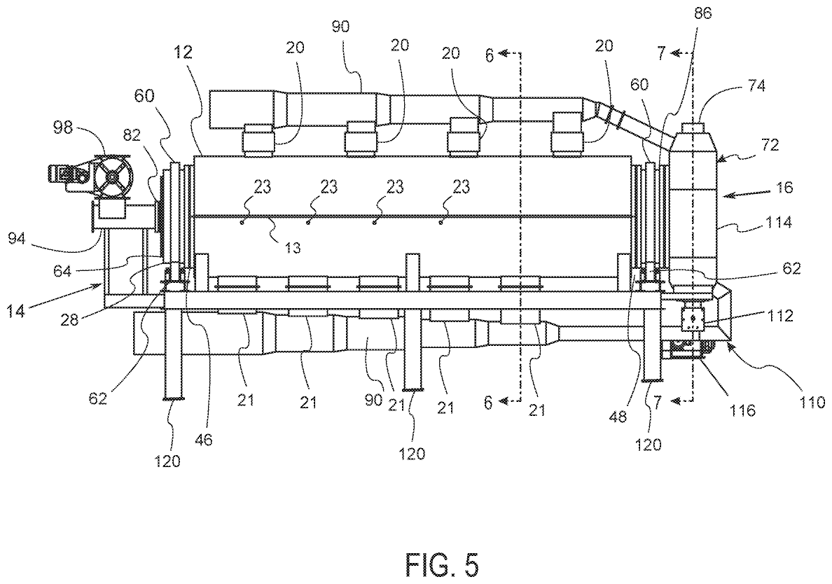

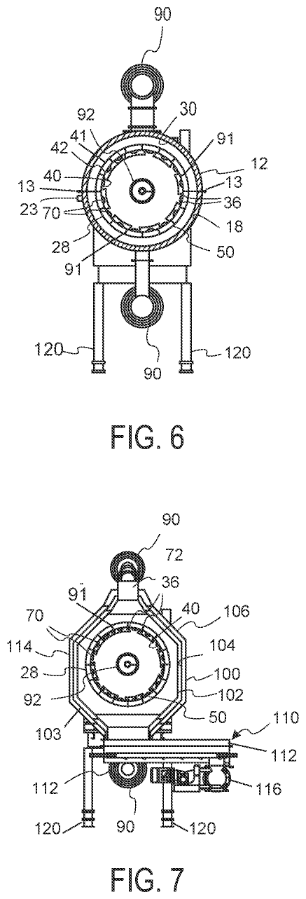

Turning now to FIGS. 5 and 6 and with continuing reference to FIG. 3, the posterior end portion 48 of the rotary drum 28 may further comprise of a plurality of raking pins 70, which in one embodiment of the invention are situated between the plurality of oscillating flights 36 and the posterior end portion 48 of the rotary drum 28. The plurality of raking pins 70 comprise various geometries and profiles and are adapted to release volatile organic compounds (VOCs) from the hot bed of thermally treated feedstock as it is processed through the thermal treatment reactor 10. The raking pins 70 achieve their function by ploughing and gently disturbing the thermally treated feedstock, which is now a flat material bed in contact with the interior 40 of the rotary drum 28. The raking pins 70 enable the release of volatile organic compounds from the thermally treated feedstock bed without lifting it. The plurality of raking pins 70 may be positioned generally equidistantly in a staggered or uniform configuration on the interior wall 42 forming a portion of the interior 40 of the rotary drum 28. It will be appreciated that the raking pins 70 may be any shape and configuration adapted to mix the feedstock within the interior 40 of the rotary drum 28.

The number of raking pins 70 varies, depending upon the size of the thermal treatment reactor 10, the size of the rotary drum 28, the volume and type of feedstock being processed, the application for which the thermal treatment reactor 10 is employed and other conditions at the site where in use. In one embodiment of the invention, there are multiple rows of raking pins 70 positioned generally equidistantly on the interior wall 42 forming the interior 40 toward the posterior end 16 of the thermal treatment reactor 10; however, the raking pins 70 may be offset with respect to each other. Other spacings and configurations, such as a parallel arrangement of the raking pins 70, would be suitable for use in the invention. Another configuration may comprise a combination of raking pins 70 and oscillating flights 36 within the same zone or region. Oscillating flights 36 may have a small flat face to gently turn over the thermally treated feedstock. Oscillating flights 36 can have the same or different construction material as the rotary drum 28 and can be welded or bolted.

The raking pins 70 are made of the same material as the rotary drum 28 or, in some cases, may be constructed of a different material, depending on the type of feedstock and product requirements. The raking pins 70 are supported or secured within the interior 40 of the rotary drum 28 by welding, bolts or other means, depending on the type of feedstock and product requirements. The raking pins 70 are held within the heated zone of the rotary drum 28 to prevent condensation on the interior 40 of the rotary drum 28. The raking pins 70 can also extend past the heated zone.

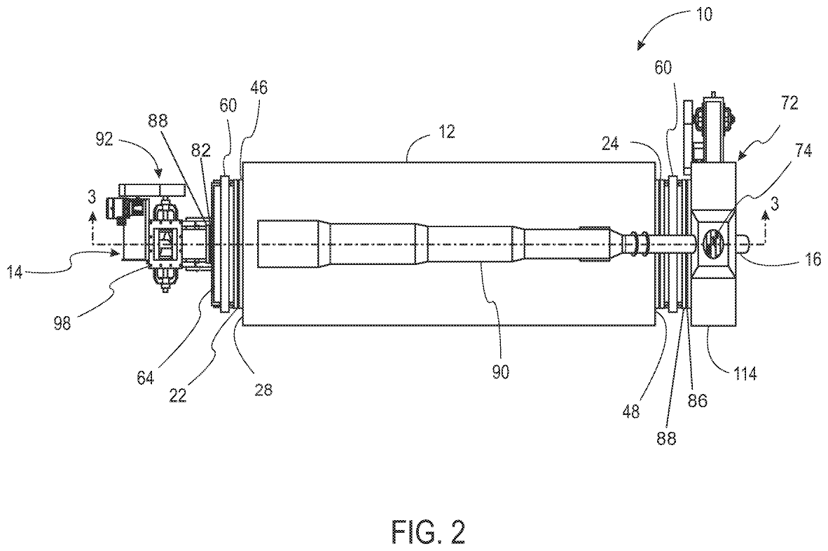

As shown in FIGS. 2 and 3, the anterior end portion 46 of the rotary drum 28 also provides a drum inlet seal 82, while the posterior end portion 48 provides a drum discharge seal 86. The drum inlet seal 82 and the drum discharge seal 86 are mounted on rolled structural angles or ells 88 that are welded onto the rotary drum 28, the infeed assembly 92 and the discharge assembly 72.

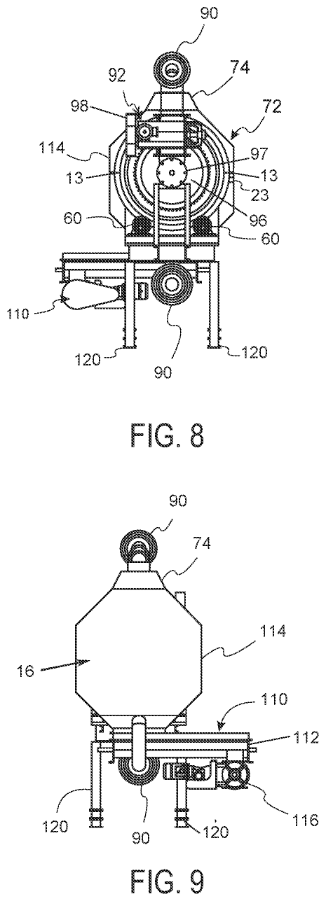

Turning now to FIGS. 7, 8 and 9, the posterior end portion 48 of the rotary drum 28 communicates with a discharge assembly 72 to transfer the hot, thermally treated feedstock. The discharge assembly 72 comprises a double-walled embodiment consisting of an outer wall 103 and inner wall 102 forming an annulus 104 therebetween. The annulus 104 permits the passage of hot gases from the thermalized feedstock in order to maintain the thermal treatment reactor 10 at a desired temperature that will minimize condensation of VOCs. The outer wall 103 of the discharge assembly 72 is insulated with insulation 106 to further mitigate VOC condensation. Hot gases emanating from the thermalized feedstock will be induced from the rotary drum 28 into the discharge assembly 72 by means of an induced draft fan (not shown) and maintaining a low or negative static pressure.

The thermal treatment reactor 10 may also comprise a plurality of heat transfer fins 91 positioned on the exterior surface 41 of the rotary drum 28 for the purpose of transferring heat from the thermal energy source into the rotary drum. The furnace 12 will receive hot gases emanating from a thermal energy source and, through the aid of the heat transfer fins 91, heat is transferred to the rotary drum 28 for the purpose of treating the feedstock. The heat transfer fins 91 may be generally longitudinal in shape and have a planar geometry but are not limited to a planar geometry. The heat transfer fins 91 may be arranged longitudinally around the circumference of the exterior surface 41 of the rotary drum 28 in a straight or staggered pattern for effective heat transfer from the furnace 12. Additionally, the heat transfer fins 91 will also increase the structural integrity of the rotary drum 28.

The thermal treatment reactor 10 comprises an infeed assembly 92 at the anterior end 14 of the thermal treatment reactor 10. The infeed assembly 92 comprises an infeed rotating screw or auger 94 discharging into the interior 40 of the rotary drum 28 through a stationary trough 97 via a breach in an inlet plate 96 at the anterior end 46 of the rotary drum. The infeed screw conveyor or auger 94 may also be equipped with an infeed airlock 98 to limit the ingress of ambient air into the rotary drum 28.

In operation of the invention, the feedstock to be thermally treated enters the thermal treatment reactor 10 in a controlled manner by means of the infeed screw conveyor or auger 94 of the infeed assembly 92. The drum inlet seal 82 seals the interface between the rotary drum 28 and infeed assembly 92 to prevent ingress of ambient air into the rotary drum 28. Inside, the thermal treatment reactor 10, is heated to a temperature ranging from about 300 degrees Fahrenheit (about 148 degrees Celsius) to about 1,500 degrees Fahrenheit (about 816 degrees Fahrenheit), preferably between 400 degrees Fahrenheit (about 204 degrees Fahrenheit) to 1,300 degrees Fahrenheit (about 704 degrees Celsius) in an oxygen-starved environment. When the reactor is heated, a small amount of water is induced into the rotary drum 28, which will be converted to steam displacing the oxygen. Alternately, an oxygen-starved condition can be created by injecting nitrogen or carbon dioxide. The oxygen-starved environment within the rotary drum 28 prevents spontaneous ignition of the feedstock during the thermal treatment process

Typical residence time of the feedstock within the rotary drum 28 can range from about 3 to about 60 minutes, although this time may vary based on the type and amount of the feedstock, the size of the thermal treatment reactor 10, the application and other conditions at the site where in use. The residence time is controlled by varying the speed of drum rotation. The drum speed can vary from about 0.5 revolutions per minute (rpm) to about 10 rpm by means of a variable-speed motor and drive assembly (not shown). The process of thermally treating the feedstock will cause a physical as well as a chemical change in the feedstock while liberating VOCs during the process.

The thermally-treated product exits the thermal treatment reactor 10 via the discharge assembly 72. The discharge assembly 72 separates the thermally-treated feedstock from the volatile organic compounds by dropping it into a liberator assembly 110 for downstream processing or oxidation, while VOC gasses rise upward through the VOC discharge 74. From the liberator assembly 110, the thermally-treated product enters into a cooling system (not shown) where the thermally treated product is cooled to a temperature safe for its exposure to atmospheric conditions. The liberator assembly 110 may comprise a plurality of agitating paddles 112 having adjustable pitches or angles at which the paddles are mounted. The agitating paddles 112 stir and agitate the hot, thermally treated feedstock, discharging it from the separator box 114. The agitating action will aid in the liberation of trapped VOCs into the separator box 114 and vent them out of the liberator assembly 110 for downstream processing. The liberatory assembly 110 will be driven with a variable-speed motor and drive assembly and insulated to prevent condensation of VOCs. The discharge from the liberator assembly 110 will be equipped with a rotary discharge airlock 116 to prevent the ingress of atmospheric air to maintain an oxygen-starved condition within the liberatory assembly and by extension rotary drum 28 of the thermal treatment reactor 10.

### Example

The efficiency of a thermal treatment reactor 10 constructed in accordance with an embodiment of the present invention is demonstrated by the following example. A test was conducted wherein a feedstock of dry corn cobs was thermally treated with a fuel comprising natural gas and process volatiles. The moisture content of the feedstock at infeed was seven percent (7%) on a weight basis and was fed to the thermal treatment reactor 10 at the rate of 10,000 pounds per hour (PPH) (4536 kilograms/hour (KG/H)) and a temperature of 40 degrees Fahrenheit (° F.) (4.44 degrees Celsius (C)). Hot gas fuel was fed to the thermal treatment reactor 10 from a thermal energy system at the rate of 5,591 SCFM (Standard Cubic Feet per Minute) (9499 cubic meters per hour (M³/H)), with a heat content of 12.15 MMBTU/H (293,971 Joules/second (J/S)) and a temperature of 1700 degrees Fahrenheit (927 degrees Celsius). Process volatiles were discharged from the thermal treatment reactor 10 and returned to the thermal energy system at the rate of 3,000 BTU/LB (British Thermal Units/Pound) (6,978,000 Joules/Kilogram) of volatiles, 6,045 PPH (2742 KG/H) of volatiles, 700 PPH (318 KG/H) of water and 18.14 MMBTU/H (5,316,309 Joules/second). The test produced a product at the rate of 1.63 short tons per hour (STPH) (1.48 metric tons per hour (MTPH)) of corn cob biocarbon, which was discharged from the thermal treatment reactor 10 having a moisture content of one percent (1%) at 3,255 PPH (1476 KG/H) and a temperature of 400° F. (204° C.). After cooling with non-potable water at 70° F. (21° C.), the resulting corn cob biocarbon product had a moisture content of five percent (5%) by weight at 3,255 PPH (1476 KG/H) and 90° F. (32° C.).

The method and operation of the invention will now be explained. The foregoing description of the invention is incorporated herein. A method of treating feedstocks comprises the steps of feeding a feedstock and insulating the rotary drum 28 to prevent condensation of volatiles. A plurality of forwarding flights 32, mixing flights 34, and/or oscillating flights 36 feed and mix the feedstock in the rotary drum 28. The method of treating feedstocks further comprises the step of releasing volatile organic compounds from the feedstock via raking pins 70. The method further comprises the step of separating the volatile organic compounds in a gaseous state from the thermally treated organic feedstock and removing the volatile organic compounds for processing or oxidation. The method further comprises the step of removing the thermally treated feedstock through a discharge assembly 72 having an inner wall 102 and an outer wall 103 and a forming an annular space 104 therebetween and passing hot gasses through the annular space to maintain the temperature of the thermally treated feedstock at a temperature that will minimize condensation of VOCs. The method further comprises the step of insulating the outer wall 103 of the discharge assembly 72 to mitigate condensation of volatile organic compounds. The method further comprises the step of inducing VOCs from the rotary drum 28 into the reactor discharge assembly 72 by maintaining a continuous negative static pressure. The method further comprises the step of cooling the thermally treated feedstock to a temperature safe for its exposure to atmospheric conditions. The thermally-treated product exits the thermal treatment reactor 10 via the discharge assembly 72 which separates the thermally-treated feedstock from the volatile organic compounds by dropping it into a liberator assembly 110 for downstream processing or oxidation, while VOC gasses rise upward through the VOC discharge 74. The thermally-treated product enters into a cooling system where the thermally-treated product is cooled to a temperature safe for its exposure to atmospheric conditions.

The invention has been described above both generically and with regard to specific embodiments. Although the invention has been set forth in what has been believed to be preferred embodiments, a wide variety of alternatives known to those of skill in the art can be selected with a generic disclosure. Changes may be made in the combination and arrangement of the various parts, elements, steps and procedures described herein without departing from the spirit and scope of the invention as defined in the following claims.

We claim:

1. A thermal treatment reactor for feedstocks, the thermal treatment reactor comprising:
a furnace for thermally treating a feedstock; and
a rotary drum having an interior in which are positioned:
a plurality of mixing flight; and
a forwarding flight to move the feedstock toward the mixing flight;
wherein the forwarding flight and at least a portion of the plurality of mixing flights are insulated to prevent condensation on the interior of the rotary drum.

2. The thermal treatment reactor of claim 1, wherein:
the furnace is fixed in position on the thermal treatment reactor;
a portion of the rotary drum is positioned partially within the furnace;
a portion of the rotary drum is positioned partially within the furnace and a portion of the rotary drum is positioned outside the furnace; and
the portion of the rotary drum that is positioned outside the furnace further comprises a double wall having two layers and insulation between the two layers of the double wall.

3. The thermal treatment reactor of claim 2, further comprising drum tracks in communication with the rotary drum.

4. The thermal treatment reactor for organic feedstocks of claim 2, further comprising a raking pin adapted to release volatile organic compounds from the thermally treated feedstock into the rotary drum.

5. The thermal treatment reactor for feedstocks of claim 1, further comprising a reactor discharge assembly positioned near a discharge end of the rotary drum to transfer thermally treated feedstock therefrom.

6. The thermal treatment reactor for feedstocks of claim 5, wherein the reactor discharge assembly forms an outer wall, an inner wall and an annular space therebetween for the passage of hot gases and to maintain a temperature that will minimize condensation of volatile organic compounds within the thermal treatment reactor.

7. The thermal treatment reactor for organic feedstocks of claim 6, wherein the outer wall of the reactor discharge assembly is insulated to mitigate condensation.

8. The thermal treatment reactor for organic feedstocks of claim 5, further comprising an induction draft fan for inducing hot gases from the furnace for downstream utilization and the volatile organic compounds from the rotary drum into the reactor discharge assembly by maintaining a negative static pressure.

9. The thermal treatment reactor for organic feedstocks of claim 1, wherein the rotary drum comprises an inlet end and a discharge end and wherein the inlet end and the discharge end of the rotary drum are insulated.

10. The thermal treatment reactor of claim 9 wherein the inlet end of the rotary drum comprises a drum inlet seal and the discharge end of the rotary drum comprises a drum discharge seal.

11. The thermal treatment reactor of claim 10 wherein the rotary drum has an exterior and wherein the drum inlet seal and the drum discharge seal are mounted on ells on the exterior of the rotary drum.

12. The thermal treatment reactor of claim 1 wherein rotary drum comprises a heated zone and wherein the exterior of the rotary drum comprises a plurality of heat transfer fins within the heated zone.

13. The thermal treatment reactor of claim 12 wherein the plurality of heat transfer fins is arranged in a straight or staggered pattern.

14. The thermal treatment reactor of claim 1 wherein the furnace further comprises a liner.

15. The thermal treatment reactor of claim 14 wherein the furnace is lined with a thermal blanket or insulating refractory.

16. The thermal treatment reactor of claim 1 wherein the rotating drum is positioned at an angle from 0.1 to 10 degrees with respect to the thermal treatment reactor.

17. The thermal treatment reactor of claim 16 wherein the angle ranges from about 0.5 degrees to 5 degrees.

18. The thermal treatment reactor of claim 1 wherein the furnace further comprises at least one port for the release of gases emanating from a thermal energy source fed to the furnace.

19. The thermal treatment reactor of claim 18 wherein the thermal energy source comprises biomass, natural gas, propane, fuel oil, process volatiles, waste heat or electricity.

20. The thermal treatment reactor of claim 19 wherein feedstock has a moisture content less than 20% on a wet basis.

21. The thermal treatment reactor of claim 19 where in the feedstock has a moisture content less than 10% on a wet basis.

22. The thermal treatment reactor of claim 1, wherein the furnace further comprises a posterior seal and an anterior seal to prevent the ingress of ambient air into the furnace.

23. The thermal treatment reactor of claim 1 further comprising an infeed assembly.

24. The thermal treatment reactor of claim 23 wherein the infeed assembly comprises a stationary trough housing a rotating screw or auger.

25. The thermal treatment reactor of claim 24 wherein the stationary trough is in communication with the rotary drum and with the rotating screw or auger.

26. The thermal treatment reactor of claim 25 further comprising a reactor inlet seal to seal an interface between the rotary drum and the stationary screw trough to prevent ingress of ambient air into the rotary drum.

27. The thermal treatment reactor of claim 1 having applicability for use as renewable energy, renewable liquid fuels, renewable syngas, organic soil amendment, air and gas filtration systems, and graphene production.

28. The thermal treatment reactor of claim 1 further comprising a liberator screw to agitate the thermally treated product discharged through the discharge assembly to liberate trapped volatiles into discharge assembly and further induced out of the thermal treatment reactor.

29. The thermal treatment reactor of claim 1 wherein infrared thermocouples mounted on the lateral side of the rotating drum to record the shell temperature of the rotating drum and thereby aid process control.

30. The thermal treatment reactor of claim 1 wherein furnace comprises a heated zone and wherein the forwarding flight is insulated from the atmosphere or held within the heated zone.

31. The thermal treatment reactor of claim 30 wherein furnace comprises a heated zone and wherein at least a portion of the mixing flights are insulated from the atmosphere or are held within the heated zone.

32. The thermal treatment reactor of claim 31 further comprising a plurality of oscillating flights.

33. The thermal treatment reactor of claim 32 wherein the furnace comprises a heated zone and wherein the plurality of oscillating flights are insulated from the atmosphere by being held within the heated zone.

34. A method of treating organic or inorganic feedstocks, the method comprising the steps of:
feeding the feedstock into a rotary drum held in a stationary furnace to thermally treat the feedstock; and
insulating the rotary drum to create a heated zone and to prevent condensation of volatiles.

35. The method of treating feedstocks of claim 34, the method further comprising the step of releasing volatile organic compounds from the furnace via raking pins.

36. The method of treating feedstocks of claim 34, the method further comprising the steps of separating the volatile organic compounds in a gaseous state from the thermally-treated organic feedstock and removing the volatile organic compounds for processing or oxidation.

37. The method of treating feedstocks of claim 34, the method further comprising the step of removing the thermally treated feedstock through a discharge assembly having an inner wall and an outer wall and a forming an annular space therebetween and passing hot gasses through the annular space to maintain the temperature of the thermally treated feedstock at a temperature that will minimize condensation of VOCs.

38. The method of claim 37 further comprising the step of insulating the outer wall of the discharge assembly to mitigate condensation of volatile organic compounds.

39. The method of claim 38 further comprising the step of inducing VOCs from the reactor discharge assembly by maintaining a continuous negative static pressure.

40. The method of claim 39 further comprising the step of cooling the thermally treated feedstock to a temperature safe for its exposure to atmospheric conditions.

41. The method of claim 40 further comprising the steps of providing a mixing flight within the rotary drum and insulating in whole or in part the mixing flight.
